(19) United States
(12) Patent Application Publication
(10) Pub. No.: US 2023/0333273 A1
(43) Pub. Date: Oct. 19, 2023

(54) Real-Time Warning And Mitigation Of Intrinsic Noise Of Transducers

(71) Applicant: Halliburton Energy Services, Inc., Houston, TX (US)

(72) Inventors: Ho Yin Ma, Singapore (SG); Xiang Wu, Singapore (SG); Batakrishna Mandal, Sugar Land, TX (US)

(73) Assignee: Halliburton Energy Services, Inc., Houston, TX (US)

(21) Appl. No.: 18/085,240

(22) Filed: Dec. 20, 2022

Related U.S. Application Data
(60) Provisional application No. 63/330,509, filed on Apr. 13, 2022.

(51) Int. Cl. G01V 1/36; E21B 49/00; G01V 11/00; G01V 3/38

(52) U.S. Cl. CPC G01V 1/368; E21B 49/00; G01V 11/00; G01V 3/38; G01V 2210/3248; G01V 2210/38

(57) ABSTRACT

A method and system for removing intrinsic transducer noises. The method may comprise disposing a measurement assembly into a wellbore, performing a measurement operation at a depth in the wellbore with the measurement assembly to record two or more raw reflected waveforms, identifying one or more intrinsic transducer noises in the two or more raw reflected waveforms, dividing the two or more raw reflected waveforms into one or more subsections, and identifying one or more incoherent measurements in the one or more subsections. The method may further comprise deriving a noise model for each of the one or more incoherent measurements, performing an inversion for each noise model, and applying an adaptive subtraction to remove the one or more intrinsic transducer noises from the two or more raw reflected waveforms.

### BACKGROUND

Wellbores drilled into subterranean formations may enable recovery of desirable fluids (e.g., hydrocarbons) using any number of different techniques. Currently, properties of subterranean formations surrounding the borehole may be determined using measurements made with suitable sensors mounted on the bottom hole assembly behind the drill bit. Measurement operations performed by downhole logging tools may identify properties within a wellbore and/or inside a formation. Current methods and system for downhole logging may emit an excitation waveform into a wellbore and record a reflection of the waveform using a transducer. The reflected waveform may be processed to determine wellbore properties.

In examples, measurement operations which utilize transducers may observe noise. Noise is an inherent observation within measurement operations and may arise from multiple factors. One example of noise within measurement operations is intrinsic transducer noise. Intrinsic transducers noise may alter the recordings of reflected waveforms and directly impact the determination of wellbore properties. Lab replication and/or modelling to simulate transducer noises is an extensive process, if not impossible to achieve. Additionally, intrinsic transducer noise may change due to well attributes such as depth, amplitude, operating frequency, downhole pressure, or temperature. The inability to remove intrinsic transducer noise leads to unreliable transducer measurements.

### BRIEF DESCRIPTION OF THE DRAWINGS

These drawings illustrate certain aspects of some examples of the present disclosure and should not be used to limit or define the disclosure.

FIG. 1 illustrates an example of a drilling system;

FIG. 2 illustrates an example of a well measurement system;

FIG. 3 illustrates an example of a measurement assembly;

FIG. 4 illustrates a schematic view of a chipset in an information handling system;

FIG. 5 illustrates the chipset in communication with other components of the information handling system;

FIG. 6 illustrates an example of one arrangement of resources in a computing network; and

FIG. 7 is a workflow for the removal of intrinsic transducer noise.

### DETAILED DESCRIPTION

Methods and systems disclosed herein may generally relate to estimating intrinsic transducer noise. Estimation of intrinsic transducer noise may be performed utilizing raw reflected waveform data by adaptively removing estimated intrinsic transducer noise from the raw reflected waveforms in log. As discussed below, this may be accomplished by dividing a log into into one or more subsections to evaluate different intrinsic transducer noise created from a variety of well attributes. Systems and methods may also determine whether raw reflected waveforms may be potentially contaminated by intrinsic transducer noises. Removal of the transducer intrinsic noise using adaptive subtraction may be carried out after all the acquisitions are completed for a measurement operation.

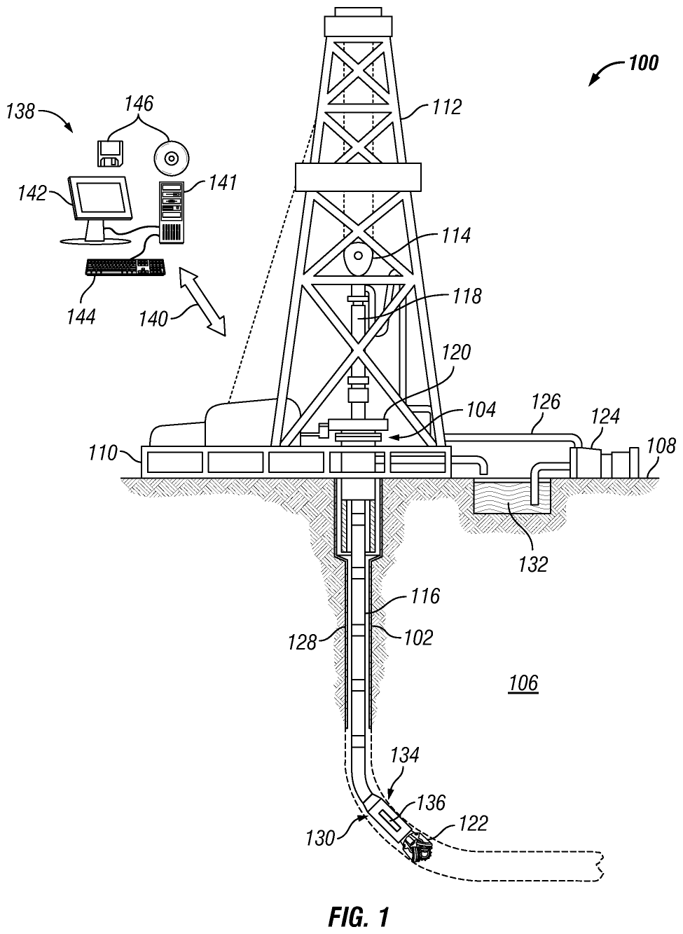

FIG. 1 illustrates an example of drilling system 100. As illustrated, wellbore 102 may extend from a wellhead 104 into a subterranean formation 106 from a surface 108. Generally, wellbore 102 may include horizontal, vertical, slanted, curved, and other types of wellbore geometries and orientations. Wellbore 102 may be cased or uncased. In examples, wellbore 102 may include a metallic member. By way of example, the metallic member may be a casing, liner, tubing, or other elongated steel tubular disposed in wellbore 102.

As illustrated, wellbore 102 may extend through subterranean formation 106. As illustrated in FIG. 1, wellbore 102 may extend generally vertically into the subterranean formation 106, however, wellbore 102 may extend at an angle through subterranean formation 106, such as horizontal and slanted wellbores. For example, although FIG. 1 illustrates a vertical or low inclination angle well, high inclination angle or horizontal placement of the well and equipment may be possible. It should further be noted that while FIG. 1 generally depicts land-based operations, those skilled in the art may recognize that the principles described herein are equally applicable to subsea operations that employ floating or sea-based platforms and rigs, without departing from the scope of the disclosure.

As illustrated, a drilling platform 110 may support a derrick 112 having a traveling block 114 for raising and lowering drill string 116. Drill string 116 may include, but is not limited to, drill pipe and coiled tubing, as generally known to those skilled in the art. A kelly 118 may support drill string 116 as it may be lowered through a rotary table 120. A drill bit 122 may be attached to the distal end of drill string 116 and may be driven either by a downhole motor and/or via rotation of drill string 116 from surface 108. Without limitation, drill bit 122 may include, roller cone bits, PDC bits, natural diamond bits, any hole openers, reamers, coring bits, and the like. As drill bit 122 rotates, it may create and extend wellbore 102 that penetrates various subterranean formations 106. A pump 124 may circulate drilling fluid through a feed pipe 126 through kelly 118, downhole through interior of drill string 116, through orifices in drill bit 122, back to surface 108 via annulus 128 surrounding drill string 116, and into a retention pit 132.

With continued reference to FIG. 1, drill string 116 may begin at wellhead 104 and may traverse wellbore 102. Drill bit 122 may be attached to a distal end of drill string 116 and may be driven, for example, either by a downhole motor and/or via rotation of drill string 116 from surface 108. Drill bit 122 may be a part of bottom hole assembly 130 at distal end of drill string 116. Bottom hole assembly 130 may further include tools for look-ahead resistivity applications. As will be appreciated by those of ordinary skill in the art, bottom hole assembly 130 may be a measurement-while drilling (MWD) or logging-while-drilling (LWD) system.

Bottom hole assembly 130 may include any number of tools, transmitters, and/or receivers to perform downhole measurement operations. For example, as illustrated in FIG. 1, bottom hole assembly 130 may include a measurement assembly 134. It should be noted that measurement assembly 134 may make up at least a part of bottom hole assembly 130. Without limitation, any number of different measurement assemblies, communication assemblies, battery assemblies, and/or the like may form bottom hole assembly 130 with measurement assembly 134. Additionally, measurement assembly 134 may form bottom hole assembly 130 itself In examples, measurement assembly 134 may include at least one transducer 136, which may be disposed at the surface of measurement assembly 134. It should be noted that transducer 136 may also be referred to as a “pinger” and/or a transducer.

Without limitation, bottom hole assembly 130 may be connected to and/or controlled by information handling system 138, which may be disposed on surface 108. Without limitation, information handling system 138 may be disposed down hole in bottom hole assembly 130. Processing of information recorded may occur down hole and/or on surface 108. Processing occurring downhole may be transmitted to surface 108 to be recorded, observed, and/or further analyzed. Additionally, information recorded on information handling system 138 that may be disposed down hole may be stored until bottom hole assembly 130 may be brought to surface 108. In examples, information handling system 138 may communicate with bottom hole assembly 130 through a communication line (not illustrated) disposed in (or on) drill string 116. In examples, wireless communication may be used to transmit information back and forth between information handling system 138 and bottom hole assembly 130. Information handling system 138 may transmit information to bottom hole assembly 130 and may receive as well as process information recorded by bottom hole assembly 130. In examples, a downhole information handling system (not illustrated) may include, without limitation, a microprocessor or other suitable circuitry, for estimating, receiving and processing waveforms from bottom hole assembly 130. Downhole information handling system (not illustrated) may further include additional components, such as memory, input/output devices, interfaces, and the like. In examples, while not illustrated, bottom hole assembly 130 may include one or more additional components, such as analog-to-digital converter, filter, and amplifier, among others, which may be used to process the measurements of bottom hole assembly 130 before they may be transmitted to surface 108. Alternatively, raw waveforms from bottom hole assembly 130 may be transmitted to surface 108.

Any suitable technique may be used for transmitting waveforms from bottom hole assembly 130 to surface 108, including, but not limited to, wired pipe telemetry, mud-pulse telemetry, acoustic telemetry, and electromagnetic telemetry. While not illustrated, bottom hole assembly 130 may include a telemetry subassembly that may transmit telemetry data to surface 108. At surface 108, pressure transducers (not shown) may convert the pressure waveform into electrical waveforms for a digitizer (not illustrated). The digitizer may supply a digital form of the telemetry waveforms to information handling system 138 via a communication link 140, which may be a wired or wireless link. The telemetry data may be analyzed and processed by information handling system 138.

As illustrated, communication link 140 (which may be wired or wireless, for example) may be provided that may transmit data from bottom hole assembly 130 to an information handling system 138 at surface 108. Information handling system 138 may include a personal computer 141, a video display 142, a keyboard 144 (i.e., other input devices.), and/or non-transitory computer-readable media 146 (e.g., optical disks, magnetic disks) that can store code representative of the methods described herein. In addition to, or in place of processing at surface 108, processing may occur downhole.

As discussed below, methods may be utilized by information handling system 138 to determine properties of subterranean formation 106. Information may be utilized to produce an image, which may be generated into a two or three-dimensional models of subterranean formation 106. These models may be used for well planning, (e.g., to design a desired path of wellbore 102). Additionally, they may be used for planning the placement of drilling systems within a prescribed area. This may allow for the most efficient drilling operations to reach a subsurface structure. During drilling operations, measurements taken within wellbore 102 may be used to adjust the geometry of wellbore 102 in real time to reach a geological target. Measurements collected from bottom hole assembly 130 of the formation properties may be used to steer drilling system 100 toward a subterranean formation 106.

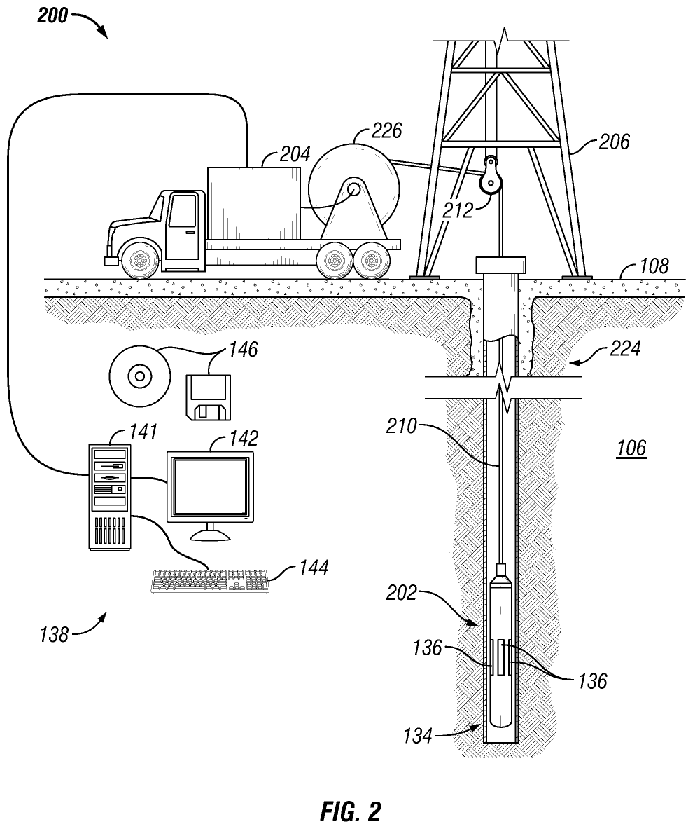

FIG. 2 illustrates a cross-sectional view of an example of well measurement system 200. As illustrated, well measurement system 200 may comprise downhole tool 202 attached a vehicle 204. In examples, it should be noted that downhole tool 202 may not be attached to a vehicle 204. Downhole tool 202 may be supported by rig 206 at surface 108. Downhole tool 202 may be tethered to vehicle 204 through conveyance 210. Conveyance 210 may be disposed around one or more sheave wheels 212 to vehicle 204. Conveyance 210 may include any suitable means for providing mechanical conveyance for downhole tool 202, including, but not limited to, wireline, slickline, coiled tubing, pipe, drill pipe, downhole tractor, or the like. In some embodiments, conveyance 210 may provide mechanical suspension, as well as electrical and/or optical connectivity, for downhole tool 202. Conveyance 210 may comprise, in some instances, a plurality of electrical conductors and/or a plurality of optical conductors extending from vehicle 204, which may provide power and telemetry. In examples, an optical conductor may utilize a battery and/or a photo conductor to harvest optical power transmitted from surface 108. Conveyance 210 may comprise an inner core of seven electrical conductors covered by an insulating wrap. An inner and outer steel armor sheath may be wrapped in a helix in opposite directions around the conductors. The electrical and/or optical conductors may be used for communicating power and telemetry between vehicle 204 and downhole tool 202. Information from downhole tool 202 may be gathered and/or processed by information handling system 138. For example, raw reflected waveforms recorded by downhole tool 202 may be stored on memory and then processed by downhole tool 202. The processing may be performed real-time during data acquisition or after recovery of downhole tool 202. Processing may alternatively occur downhole or may occur both downhole and at surface. In some embodiments, raw reflected waveforms recorded by downhole tool 202 may be conducted to information handling system 138 by way of conveyance 210. Information handling system 138 may process raw reflected waveforms, and the information contained therein may be displayed for an operator to observe and stored for future processing and reference. Information handling system 138 may also contain an apparatus for supplying control waveforms and power to downhole tool 202.

Systems and methods of the present disclosure may be implemented, at least in part, with information handling system 138. While shown at surface 108, information handling system 138 may also be located at another location, such as remote from borehole 224. Information handling system 138 may include any instrumentality or aggregate of instrumentalities operable to compute, estimate, classify, process, transmit, receive, retrieve, originate, switch, store, display, manifest, detect, record, reproduce, handle, or utilize any form of information, intelligence, or data for business, scientific, control, or other purposes. For example, an information handling system 138 may be a personal computer 141, a network storage device, or any other suitable device and may vary in size, shape, performance, functionality, and price. Information handling system 138 may include random access memory (RAM), one or more processing resources such as a central processing unit (CPU) or hardware or software control logic, ROM, and/or other types of nonvolatile memory. Additional components of the information handling system 138 may include one or more disk drives, one or more network ports for communication with external devices as well as various input and output (I/O) devices, such as a keyboard 144, a mouse, and a video display 142. Information handling system 138 may also include one or more buses operable to transmit communications between the various hardware components. Furthermore, video display 142 may provide an image to a user based on activities performed by personal computer 141. For example, producing images of geological structures created from recorded raw reflected waveforms. By way of example, video display unit may produce a plot of depth versus the two cross-axial components of the gravitational field and versus the axial component in borehole coordinates. The same plot may be produced in coordinates fixed to the Earth, such as coordinates directed to the North, East and directly downhole (Vertical) from the point of entry to the borehole. A plot of overall (average) density versus depth in borehole or vertical coordinates may also be provided. A plot of density versus distance and direction from the borehole versus vertical depth may be provided. It should be understood that many other types of plots are possible when the actual position of the measurement point in North, East and Vertical coordinates is taken into account. Additionally, hard copies of the plots may be produced in paper logs for further use.

Alternatively, systems and methods of the present disclosure may be implemented, at least in part, with non-transitory computer-readable media 146. Non-transitory computer-readable media 146 may include any instrumentality or aggregation of instrumentalities that may retain data and/or instructions for a period of time. Non-transitory computer-readable media 146 may include, for example, storage media such as a direct access storage device (e.g., a hard disk drive or floppy disk drive), a sequential access storage device (e.g., a tape disk drive), compact disk, CD-ROM, DVD, RAM, ROM, electrically erasable programmable read-only memory (EEPROM), and/or flash memory; as well as communications media such wires, optical fibers, microwaves, radio waves, and other electromagnetic and/or optical carriers; and/or any combination of the foregoing.

In examples, rig 206 includes a load cell (not shown) which may determine the amount of pull-on conveyance 210 at the surface of borehole 224. Information handling system 138 may comprise a safety valve (not illustrated) which controls the hydraulic pressure that drives drum 226 on vehicle 204 which may reel up and/or release conveyance 210 which may move downhole tool 202 up and/or down borehole 224. The safety valve may be adjusted to a pressure such that drum 226 may only impart a small amount of tension to conveyance 210 over and above the tension necessary to retrieve conveyance 210 and/or downhole tool 202 from borehole 224. The safety valve is typically set a few hundred pounds above the amount of desired safe pull-on conveyance 210 such that once that limit is exceeded, further pull-on conveyance 210 may be prevented.

As illustrated in FIG. 2, downhole tool 202 may include measurement assembly 134. It should be noted that measurement assembly 134 may make up at least a part of downhole tool 202. Without limitation, any number of different measurement assemblies, communication assemblies, battery assemblies, and/or the like may form downhole tool 202 with measurement assembly 134. Additionally, measurement assembly 134 may form downhole tool 202 itself In examples, measurement assembly 134 may include any number of transducers 136, which may be disposed at or near the surface of measurement assembly 134. Without limitation, there may be four transducers 136 that may be disposed ninety degrees from each other. However, it should be noted that there may be any number of transducers 136 disposed within measurement assembly 134 at any degree from each other.

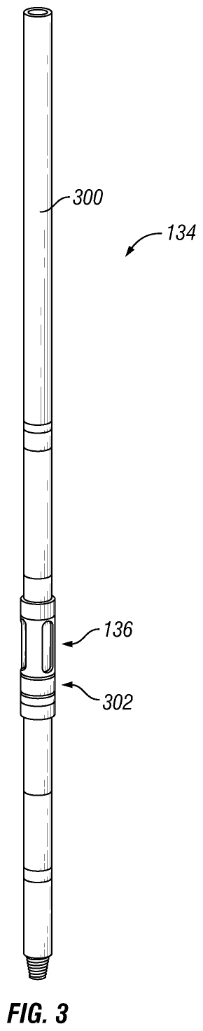

FIG. 3 illustrates a close-up view of an example of measurement assembly 134. As illustrated, measurement assembly 134 may include at least one battery section 300 and at least one instrument section 302. Battery section 300 may operate and function to enclose and/or protect at least one battery that may be disposed in battery section 300. Without limitation, battery section 300 may also operate and function to power measurement assembly 134. Specifically, battery section 300 may power at least one transducer 136, which may be disposed at any end of battery section 300 in instrument section 302.

Instrument section 302 may house at least one transducer 136. Transducers 136 may function and operate to generate and record excitations within a wellbore 102 (e.g., referring to FIG. 1) and/ or surrounding subterranean formation 106. For example, during operations, transducer 136 may transmit an excitation into wellbore 102 (e.g., referring to FIG. 1). Without limitation, the excitation may be in the form of a pressure pulse, current, electromagnetic field, radio frequency, and/or any other suitable medium. This may allow for transducer 136 to be an ultrasonic device, acoustic device, electromagnetic device, radio frequency device, and/or the like. In examples, may be made of piezo-ceramic crystals, or optionally magnetostrictive materials or other materials that generate an acoustic pulse when activated electrically or otherwise. In one or more examples, transducers 136 may also include backing materials and matching layers. Additionally, transducer 136 may include coils, antennas, and/or the like. It should be noted that transducers 136 and/or instrument section 302 may be removable and replaceable, for example, in the event of damage or failure.

During operations, in examples where transducer 136 (e.g., referring to FIG. 1) may emit pressure waveforms, specifically an ultrasonic pressure pulse wave, the pressure pulse may have a frequency range from 50 Hz-1 MHz, centered around 500 kHz. It should be noted that pulse waveforms may be emitted with different frequency content. The emitted pressure waveform may travel through wellbore 102 and subterrain formation 106 where it refracts and reflects back to transducer 136 as a waveform. Recordings and/or measurements of a raw waveforms taken by transducer 136 may be transmitted to information handling system 138 as a raw reflected waveform by any suitable means, as discussed above. Transmission may be performed in real-time (transmitted to the surface via mud- pulse, wired-pipe or other telemetry) or post-drill (from data stored in the tool memory and recovered at the surface during tripping). Information handling system 138 may form a log from recordings and/or measurements taken by transducer 136. To form a log, information handling system 138 may populate each individual raw waveform onto the log sequentially corresponding to the depth each raw reflected waveform was recorded. As such the log varies and may be dependent on depth. Information handling system may implement processing and raw reflected waveform processing while forming the log.

During measurement operation, transducers 136 may record intrinsic transducer noise. Intrinsic transducer noise, expected or unexpected, might emerge within logs during field data acquisitions. In examples, intrinsic transducer noises may appear during measurement operation in a logging environment with in-situ temperature and pressure changes. Strong intrinsic transducers noise may tamper with raw reflected waveforms measured by measurement assembly 134 and may impact answer products. Information handling system 138 may be employed to evaluate intrinsic transducer noise.

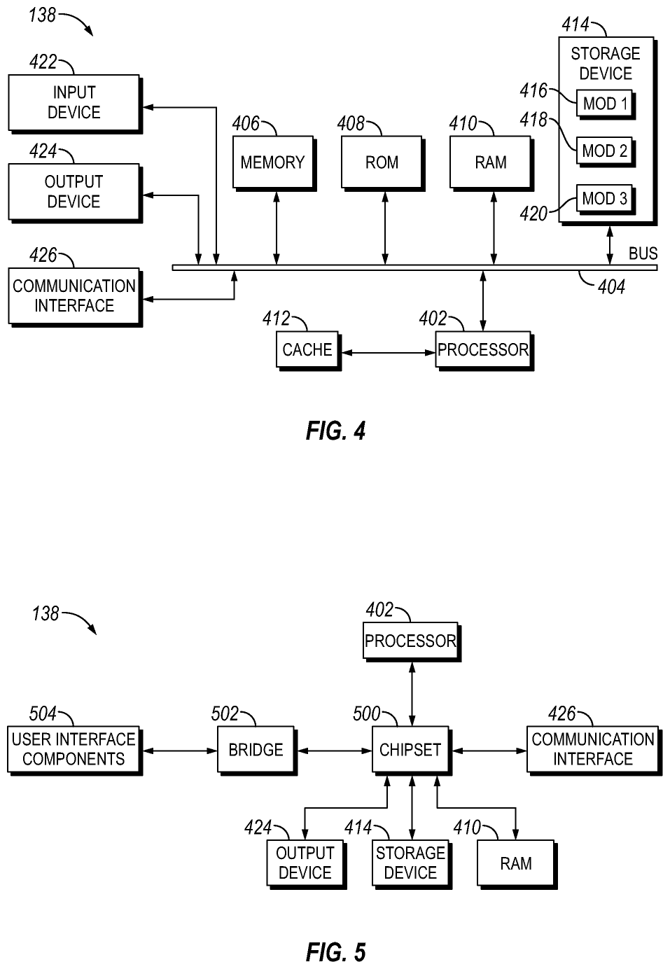

FIG. 4 illustrates an example information handling system 138 which may be employed to perform various steps, methods, and techniques disclosed herein. As illustrated, information handling system 138 includes a processing unit (CPU or processor) 402 and a system bus 404 that couples various system components including system memory 406 such as read only memory (ROM) 408 and random access memory (RAM) 410 to processor 402. Processors disclosed herein may all be forms of this processor 402. Information handling system 138 may include a cache 412 of high-speed memory connected directly with, in close proximity to, or integrated as part of processor 402. Information handling system 138 copies data from memory 406 and/or storage device 414 to cache 412 for quick access by processor 402. In this way, cache 412 provides a performance boost that avoids processor 402 delays while waiting for data. These and other modules may control or be configured to control processor 402 to perform various operations or actions. Other system memory 406 may be available for use as well. Memory 406 may include multiple different types of memory with different performance characteristics. It may be appreciated that the disclosure may operate on information handling system 138 with more than one processor 402 or on a group or cluster of computing devices networked together to provide greater processing capability. Processor 402 may include any general purpose processor and a hardware module or software module, such as first module 416, second module 418, and third module 420 stored in storage device 414, configured to control processor 402 as well as a special-purpose processor where software instructions are incorporated into processor 402. Processor 402 may be a self-contained computing system, containing multiple cores or processors, a bus, memory controller, cache, etc. A multi-core processor may be symmetric or asymmetric. Processor 402 may include multiple processors, such as a system having multiple, physically separate processors in different sockets, or a system having multiple processor cores on a single physical chip. Similarly, processor 402 may include multiple distributed processors located in multiple separate computing devices but working together such as via a communications network. Multiple processors or processor cores may share resources such as memory 406 or cache 412 or may operate using independent resources. Processor 402 may include one or more state machines, an application specific integrated circuit (ASIC), or a programmable gate array (PGA) including a field PGA (FPGA).

Each individual component discussed above may be coupled to system bus 404, which may connect each and every individual component to each other. System bus 404 may be any of several types of bus structures including a memory bus or memory controller, a peripheral bus, and a local bus using any of a variety of bus architectures. A basic input/output (BIOS) stored in ROM 408 or the like, may provide the basic routine that helps to transfer information between elements within information handling system 138, such as during start-up. Information handling system 138 further includes storage devices 414 or computer-readable storage media such as a hard disk drive, a magnetic disk drive, an optical disk drive, tape drive, solid-state drive, RAM drive, removable storage devices, a redundant array of inexpensive disks (RAID), hybrid storage device, or the like. Storage device 414 may include software modules 416, 418, and 420 for controlling processor 402. Information handling system 138 may include other hardware or software modules. Storage device 414 is connected to the system bus 404 by a drive interface. The drives and the associated computer-readable storage devices provide nonvolatile storage of computer-readable instructions, data structures, program modules and other data for information handling system 138. In one aspect, a hardware module that performs a particular function includes the software component stored in a tangible computer-readable storage device in connection with the necessary hardware components, such as processor 402, system bus 404, and so forth, to carry out a particular function. In another aspect, the system may use a processor and computer-readable storage device to store instructions which, when executed by the processor, cause the processor to perform operations, a method or other specific actions. The basic components and appropriate variations may be modified depending on the type of device, such as whether information handling system 138 is a small, handheld computing device, a desktop computer, or a computer server. When processor 402 executes instructions to perform “operations”, processor 402 may perform the operations directly and/or facilitate, direct, or cooperate with another device or component to perform the operations.

As illustrated, information handling system 138 employs storage device 414, which may be a hard disk or other types of computer-readable storage devices which may store data that are accessible by a computer, such as magnetic cassettes, flash memory cards, digital versatile disks (DVDs), cartridges, random access memories (RAMs) 410, read only memory (ROM) 408, a cable containing a bit stream and the like, may also be used in the exemplary operating environment. Tangible computer-readable storage media, computer-readable storage devices, or computer-readable memory devices, expressly exclude media such as transitory waves, energy, carrier waveforms, electromagnetic waves, and waveforms per se.

To enable user interaction with information handling system 138, an input device 422 represents any number of input mechanisms, such as a microphone for speech, a touch-sensitive screen for gesture or graphical input, keyboard, mouse, motion input, speech and so forth. Additionally, input device 422 may take in data from one or more transducers 136 (e.g., referring to FIG. 1), discussed above. An output device 424 may also be one or more of a number of output mechanisms known to those of skill in the art. In some instances, multimodal systems enable a user to provide multiple types of input to communicate with information handling system 138. Communications interface 426 generally governs and manages the user input and system output. There is no restriction on operating on any particular hardware arrangement and therefore the basic hardware depicted may easily be substituted for improved hardware or firmware arrangements as they are developed.

As illustrated, each individual component describe above is depicted and disclosed as individual functional blocks. The functions these blocks represent may be provided through the use of either shared or dedicated hardware, including, but not limited to, hardware capable of executing software and hardware, such as a processor 402, that is purpose-built to operate as an equivalent to software executing on a general purpose processor. For example, the functions of one or more processors presented in FIG. 4 may be provided by a single shared processor or multiple processors. (Use of the term “processor” should not be construed to refer exclusively to hardware capable of executing software.) Illustrative embodiments may include microprocessor and/or digital waveform processor (DSP) hardware, read-only memory (ROM) 408 for storing software performing the operations described below, and random-access memory (RAM) 410 for storing results. Very large-scale integration (VLSI) hardware embodiments, as well as custom VLSI circuitry in combination with a general-purpose DSP circuit, may also be provided.

The logical operations of the various methods, described below, are implemented as: (1) a sequence of computer implemented steps, operations, or procedures running on a programmable circuit within a general use computer, (2) a sequence of computer implemented steps, operations, or procedures running on a specific-use programmable circuit; and/or (3) interconnected machine modules or program engines within the programmable circuits. Information handling system 138 may practice all or part of the recited methods, may be a part of the recited systems, and/or may operate according to instructions in the recited tangible computer-readable storage devices. Such logical operations may be implemented as modules configured to control processor 402 to perform particular functions according to the programming of software modules 416, 418, and 420.

In examples, one or more parts of the example information handling system 138, up to and including the entire information handling system 138, may be virtualized. For example, a virtual processor may be a software object that executes according to a particular instruction set, even when a physical processor of the same type as the virtual processor is unavailable. A virtualization layer or a virtual “host” may enable virtualized components of one or more different computing devices or device types by translating virtualized operations to actual operations. Ultimately however, virtualized hardware of every type is implemented or executed by some underlying physical hardware. Thus, a virtualization compute layer may operate on top of a physical compute layer. The virtualization compute layer may include one or more virtual machines, an overlay network, a hypervisor, virtual switching, and any other virtualization application.

FIG. 5 illustrates an example information handling system 138 having a chipset architecture that may be used in executing the described method and generating and displaying a graphical user interface (GUI). Information handling system 138 is an example of computer hardware, software, and firmware that may be used to implement the disclosed technology. Information handling system 138 may include a processor 402, representative of any number of physically and/or logically distinct resources capable of executing software, firmware, and hardware configured to perform identified computations. Processor 402 may communicate with a chipset 500 that may control input to and output from processor 402. In this example, chipset 500 outputs information to output device 424, such as a display, and may read and write information to storage device 414, which may include, for example, magnetic media, and solid-state media. Chipset 500 may also read data from and write data to RAM 410. A bridge 502 for interfacing with a variety of user interface components 504 may be provided for interfacing with chipset 500. Such user interface components 504 may include a keyboard, a microphone, touch detection and processing circuitry, a pointing device, such as a mouse, and so on. In general, inputs to information handling system 138 may come from any of a variety of sources, machine generated and/or human generated.

Chipset 500 may also interface with one or more communication interfaces 426 that may have different physical interfaces. Such communication interfaces may include interfaces for wired and wireless local area networks, for broadband wireless networks, as well as personal area networks. Some applications of the methods for generating, displaying, and using the GUI disclosed herein may include receiving ordered datasets over the physical interface or be generated by the machine itself by processor 402 analyzing data stored in storage device 414 or RAM 410. Further, information handling system 138 receive inputs from a user via user interface components 504 and execute appropriate functions, such as browsing functions by interpreting these inputs using processor 402.

In examples, information handling system 138 may also include tangible and/or non-transitory computer-readable storage devices for carrying or having computer-executable instructions or data structures stored thereon. Such tangible computer-readable storage devices may be any available device that may be accessed by a general purpose or special purpose computer, including the functional design of any special purpose processor as described above. By way of example, and not limitation, such tangible computer-readable devices may include RAM, ROM, EEPROM, CD-ROM or other optical disk storage, magnetic disk storage or other magnetic storage devices, or any other device which may be used to carry or store desired program code in the form of computer-executable instructions, data structures, or processor chip design. When information or instructions are provided via a network, or another communications connection (either hardwired, wireless, or combination thereof), to a computer, the computer properly views the connection as a computer-readable medium. Thus, any such connection is properly termed a computer-readable medium. Combinations of the above should also be included within the scope of the computer-readable storage devices.

Computer-executable instructions include, for example, instructions and data which cause a general-purpose computer, special purpose computer, or special purpose processing device to perform a certain function or group of functions. Computer-executable instructions also include program modules that are executed by computers in stand-alone or network environments. Generally, program modules include routines, programs, components, data structures, objects, and the functions inherent in the design of special-purpose processors, etc. that perform particular tasks or implement particular abstract data types. Computer-executable instructions, associated data structures, and program modules represent examples of the program code means for executing steps of the methods disclosed herein. The particular sequence of such executable instructions or associated data structures represents examples of corresponding acts for implementing the functions described in such steps.

In additional examples, methods may be practiced in network computing environments with many types of computer system configurations, including personal computers, hand-held devices, multi-processor systems, microprocessor-based or programmable consumer electronics, network PCs, minicomputers, mainframe computers, and the like. Examples may also be practiced in distributed computing environments where tasks are performed by local and remote processing devices that are linked (either by hardwired links, wireless links, or by a combination thereof) through a communications network. In a distributed computing environment, program modules may be located in both local and remote memory storage devices.

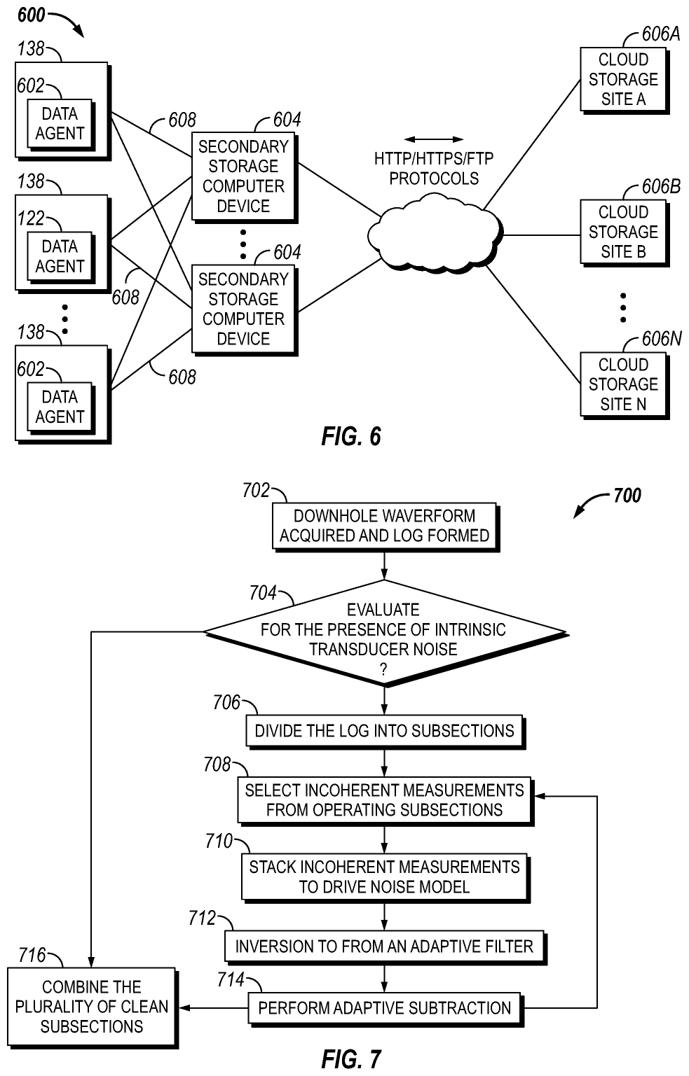

FIG. 6 illustrates an example of one arrangement of resources in a computing network 600 that may employ the processes and techniques described herein, although many others are of course possible. As noted above, an information handling system 138, as part of their function, may utilize data, which includes files, directories, metadata (e.g., access control list (ACLS) creation/edit dates associated with the data, etc.), and other data objects. The data on the information handling system 138 is typically a primary copy (e.g., a production copy). During a copy, backup, archive or other storage operation, information handling system 138 may send a copy of some data objects (or some components thereof) to a secondary storage computing device 604 by utilizing one or more data agents 602.

A data agent 602 may be a desktop application, website application, or any software-based application that is run on information handling system 138. As illustrated, information handling system 138 may be disposed at any rig site (e.g., referring to FIG. 1) or repair and manufacturing center. Data agent 602 may communicate with a secondary storage computing device 604 using communication protocol 608 in a wired or wireless system. Communication protocol 608 may function and operate as an input to a website application. In the website application, field data related to pre- and post-operations, generated DTCs, notes, and the like may be uploaded. Additionally, information handling system 138 may utilize communication protocol 608 to access processed measurements, operations with similar DTCs, troubleshooting findings, historical run data, and/or the like. This information is accessed from secondary storage computing device 604 by data agent 602, which is loaded on information handling system 138.

Secondary storage computing device 604 may operate and function to create secondary copies of primary data objects (or some components thereof) in various cloud storage sites 606A-N. Additionally, secondary storage computing device 604 may run determinative algorithms on data uploaded from one or more information handling systems 138, discussed further below. Communications between the secondary storage computing devices 604 and cloud storage sites 606A-N may utilize REST protocols (Representational state transfer interfaces) that satisfy basic C/R/U/D semantics (Create/Read/Update/Delete semantics), or other hypertext transfer protocol (“HTTP”)-based or file-transfer protocol (“FTP”)-based protocols (e.g., Simple Object Access Protocol).

In conjunction with creating secondary copies in cloud storage sites 606A-N, the secondary storage computing device 604 may also perform local content indexing and/or local object-level, sub-object-level or block-level deduplication when performing storage operations involving various cloud storage sites 606A-N. Cloud storage sites 606A-N may further record and maintain DTC code logs for each downhole operation or run, map DTC codes, store repair and maintenance data, store operational data, and/or provide outputs from determinative algorithms that are fun at cloud storage sites 606A-N. In examples, computing network 600 may be communicatively coupled to downhole drilling system 100. Discussed below are methods and systems to estimate the intrinsic transducer noise using recorded raw reflected waveform data. Utilizing computing network 600 and/or one or more information handling systems 138 (e.g., referring to FIG. 1), intrinsic transducer noises may be estimated and/or removed adaptively from raw reflected waveforms recorded during measurement operations.

FIG. 7 illustrates workflow 700 to remove intrinsic transducer noise from raw reflected waveforms. Intrinsic transducer noise may be estimated through a consistent convolution between a filter and a known noise model, which may then be subtracted away from the raw waveforms. Workflow 700 may be performed on one or more information handling systems 138 (e.g., referring to FIG. 1). In examples, information handling system 138 may be disposed on measurement assembly 134 and/or with a second information handling system 138 disposed at surface 108. During measurement operations, intrinsic transducer noise may arise from internal noise inherently produced by manufacturing inaccuracies, non-exact functionality, or failure of internal component, or modified internal or external components of transducer 136. Intrinsic transducer noise may be removed utilizing processing techniques in workflow 700.

In block 702 two or more raw reflected waveforms may be acquired using on or more transducers 136 (e.g., referring to FIG. 1) and a log may be formed by information handling system 138, as described in FIG. 3. In block 704, the log may be evaluated for the presence of intrinsic transducer noise in real time. Herein real time may be defined as processing measurements within a time range of 0.01 ns-1 ns, 1 ns-1 ms, 1 ms-1 s, or is to 1 minute. The evaluation may be performed on the raw reflected waveforms within the log by the method of waveform processing to extract the stationary component in time. The evaluation may determine if there exists the presence of intrinsic transducer noise in the raw reflected waveforms. If intrinsic transducer noise is identified in the raw reflected waveforms, then workflow 700 may proceed to block 706, otherwise workflow 700 may proceed to block 716.

In block 706, the log from block 702 may be divided into two or more subsections with similar intrinsic transducer noise characteristics. Dividing the log may allow for different characteristics of intrinsic transducer noise to be grouped, based on varying well attributes. For example, arrival timing of intrinsic transducer noises may be consistent with similar temperature or pressure ranges. However, the amplitude and frequency components of intrinsic transducer noise may change with pressure and temperature as bottom hole assembly 130 (e.g., referring to FIG. 1) traverses subterranean formation 106. As such, the log from block 702 may be divided into different subsections with similar intrinsic transducer noise characteristics. Intrinsic transducer noise may be dependent and variable on well attributes. In examples, subsections may be divided by different well attributes such as depth, amplitude, operating frequency, downhole pressure, or temperature. As such, diving raw reflected waveforms from the log into different subsections by well attributes may allow intrinsic transducer noise to be evaluated without variations for each subsection. In further examples, overlapping of reflected raw reflected waveforms may be possible. For example, the same raw waveform may be in more than one subsection of the two or more subsections.

Blocks 708-714 may be an iterative process which implements an operating subsection from the two or more subsections at a time. Herein an operating subsection may be defined as a subsection from the two or more subsections which may be processed in blocks 708-714, to be discussed below. Every subsection from the two or more subsections may be implemented within blocks 708-714 at least once as the operating subsection. In examples, block 706 may be forgone and the log processed in blocks 708-714 in one step, rather than using operating subsections iteratively.

In block 708 incoherent measurements from raw reflected waveforms may be selected for an operating subsection. Selecting incoherent measurements within the operating subsection may be performed by comparing arrival time of separate raw reflected waveforms. For example, the arrival time of two raw reflected waveforms without intrinsic transducer noise may be different, whereas two raw reflected waveforms with intrinsic transducer noise arrival times may be the same. Herein, the arrival time of two raw reflected waveforms is the same if they are within a dynamic margin of error which may be defined as 0.01%-0.1%, 0.1%-1%, or 1%-10%. Further, a clean raw reflected waveforms may be defined as a recorded raw reflected waveforms with nominal noise interference. In examples, raw reflected waveforms located outside the operating subsection with the same incoherent measurements may be selected. In block 710 a noise model may be derived from processed incoherent data. Noise models may be derived by stacking to amplify the noise-to-waveform ratio. Herein stacking is defined as averaging all selected incoherent measurements from block 708. The stacked raw reflected waveforms may be further processed by cancelling the residuals that are identified by a user as unrelated noise. Additionally, raw reflected waveform may be tapered out for a smooth noise model. Stacking may increase waveform to noise ratio for the operating subsection and derives a noise model for the operating sub section.

In block 712 an inversion is performed on the operating subsection and noise model from block 710 to form an adaptive filter. In examples, the inversion may be an iterative process to derive the convergence between a built-in parameter formed by the operating subsection and noise model. The adaptive filter may comprise a length defined by an adjustable intended noise removal effect parameter. With respect to the derived noise model, the adaptive filter may be solved using the following inverse problem:

\hat{f}=argmin_{f}∥w−f*m∥ₚ (1)

where m denotes the derived noise model, \hat{f} denotes the inverted adaptive filter, ∥⋅∥ₚ represents a traditional [symbol] p-norm function with p≥1, and argmin_{f} is the argument, answer, or target which minimizes the inverted filter.

In block 714, an adaptive subtraction may be applied to an operating subsection with an adaptive filter to remove intrinsic transducer to remove intrinsic transducer noise. The adaptive subtraction width is equal to the inverted filter and may remove intrinsic transducer noise from the raw reflected waveforms measured in block 702. Adaptive subtraction may be computed in frequency or time domain. In examples, adaptive subtraction may be performed in the time domain using:

\tilde{w}=w−f*m (2)

where f denotes the inverted adaptive filter, \tilde{w} denotes a clean waveform(s), w denotes a raw reflected waveform(s), and m denotes the noise model. Further, adaptive subtraction may be performed in the frequency domain using:

\tilde{w}=w−\hat{f}*m (3)

where \hat{f} denotes the inverted adaptive filter, \tilde{w} denotes a clean waveform(s), w denotes a raw reflected waveform(s), and m denotes the noise model.

Different intrinsic transducer noise removal may be achieved by adjusting the filter length for \hat{f}. Mathematically, the filter length depicts the maximum lag of the noise model when evaluating the autocorrelation of the noise model, and the cross-correlation between the noise model and input raw reflected waveform. A shorter filter length may restrict the removal of intrinsic transducer noise where the recording timing is proximate to the noise model. A longer filter length may remove the noise model frequency components from the raw reflected waveform such as echoes or ringdown. The product of block 714 produces an intrinsic noise free operating subsection. Blocks 708-714 may be repeated for all raw data subgroups to remove intrinsic transducer noise in all data and produce a plurality of clean subsections. In block 716, the processing is completed and all clean subsections are combined to form a plurality of clean subsections.

In examples, workflow 700 may be utilized to remove at least a part of a variety of transducer hardware-related noises, for example, repeated echoes, additional wave propagation mechanisms and ringdowns. Additionally, electrical noises associated with the operation of transducer systems and logging tool assembly may be removed. Without limitation, workflow 700 may be applied to data of a wireline, a logging-while-drilling type of measurements, including acoustics, electromagnetic, seismic and optics. In examples, the detection of intrinsic transducer noise could be achieved via data visualization, statistics and frequency components of raw reflected waveforms, or machine learning classification.

Workflow 700 may also be utilized as a postprocessing procedure to remove intrinsic transducer noise evaluated from raw reflected waveforms, which is evaluated in real-time. Additionally, the generation of adaptive filter from input and noise model may be achieved by deterministic methods, iterative algorithms, or machine learning-based equation solving algorithms. Without limitations, the methods and systems descried above may be utilized in a cased hole operation to evaluate casing integrity and cement bond quality.

Currently technology is does not estimate and remove intrinsic transducer noise, from raw reflected waveform data. Systems and methods described above estimate and remove intrinsic transducer noise. The estimated intrinsic transducer noise may be removed adaptively from the raw reflected waveforms due to the accumulation of contaminants from the fluids and capable of making measurements in conducting flowlines. Additionally, improvements over current technology reside in adapting to changing intrinsic transducer noise due to varying well attributes.

Statement 1: A method comprising disposing a measurement assembly into a wellbore, performing a measurement operation in the wellbore with the measurement assembly to record two or more raw reflected waveforms at one or more depths in the wellbore with one or more transducers, and forming a log with the two or more raw reflected waveforms. The method may further comprise dividing the log into two or more subsections forming one or more operating subsections from the two or more subsections, identifying one or more incoherent measurements within the one or more operating subsections, and deriving a noise model for each of the one or more incoherent measurements. The method may further comprise performing an inversion for each noise model to form an adaptive filter; and applying an adaptive subtraction with the adaptive filter on the one or more operating subsections to remove an intrinsic transducer noise.

Statement 2: The method of statement 1, wherein dividing the log into two or more subsections is based at least in part on one or more well attributes.

Statement 3: The method of statement 2, wherein the one or more well attributes are depth, amplitude, operating frequency, downhole pressure, or temperature.

Statement 4: The methods of statements 1-3, further comprising evaluating the log for intrinsic transducer noise in real time.

Statement 5: The methods of statements 1-4, wherein identifying one or more incoherent measurements within the one or more operating subsections is performed by comparing an arrival time to each of the two or more raw reflected waveforms within the operating subsection.

Statement 6: The method of statement 5, wherein if the arrival time of two or more raw reflected waveforms are different indicates the intrinsic transducer noise is not present.

Statement 7: The methods of statements 5 or 6, wherein if the arrival time of two or more raw reflected waveforms are identical indicates the intrinsic transducer noise is present.

Statement 8: The methods of statements 1-7, wherein the noise model for each of the one or more incoherent measurements is derived using at least a part of the one or more incoherent measurements.

Statement 9: The methods of statements 1-8, wherein the inversion is:

\hat{f}=argmin_{f}∥w−f*m∥ₚ,

wherein, f is the adaptive filter, \hat{f} is an inverted adaptive filter formed from the adaptive filter, ∥⋅∥ₚ is an [symbol] p-norm with p≥1, m is the noise model, w is the raw reflected waveforms within the operating subsection and argmin_{f} is argument, answer, or target which minimizes the inverted filter.

Statement 10: The method of statement 9, wherein the adaptive subtraction is:

\tilde{w}=w−\hat{f}*m,

wherein \tilde{w} is a clean subsection.

Statement 11: The method of statement 10, wherein the adaptive subtraction is:

\tilde{w}=w−f*m,

wherein \tilde{w} is a clean subsection.

Statement 12: A system comprising one or more transducers configured to record two or more raw reflected waveforms at one or more depths in a wellbore, an information handling system configured to: form a log with the two or more raw reflected waveforms, divide the log into two or more subsections, form one or more operating subsections from the two or more subsections, and identify one or more incoherent measurements within the one or more operating subsections. The information handling system may be further configured to derive a noise model for each of the one or more incoherent measurements, perform an inversion for each noise model to form an adaptive filter, and apply an adaptive subtraction with the adaptive filter on the one or more operating subsections to remove intrinsic transducer noise.

Statement 13: The system of statement 12, wherein the log is divided based on well attributes, wherein well attributes are depth, amplitude, operating frequency, downhole pressure, or temperature.

Statement 14: The system of statements 12 or 13, wherein the information handling system is further configured to evaluate the log for intrinsic transducer noise in real time.

Statement 15: The system of statements 12-14, wherein the noise model for each of the one or more incoherent measurements is derived by at least averaging all selected incoherent measurements, wherein the inversion is:

\hat{f}=argmin_{f}∥w−f*m∥ₚ,

wherein f is the adaptive filter, \hat{f} is an inverted adaptive filter formed from the adaptive filter, ∥⋅∥ₚ is an [symbol] p-norm with p≥1, m is the noise model, w is the raw reflected waveforms within the operating subsection and argmin_{f} is argument, answer, or target which minimizes the inverted filter.

Statement 16: The system of statement 15, wherein the adaptive subtraction is:

\tilde{w}=w−\hat{f}*m,

wherein \tilde{w} is a clean subsection.

Statement 17: A method comprising disposing a measurement assembly into a wellbore, performing a measurement operation in the wellbore with the measurement assembly to record two or more raw reflected waveforms at one or more depths in the wellbore with one or more transducers, forming a log with the two or more raw reflected waveforms, and identifying one or more incoherent measurements within the log. The method may further comprise deriving a noise model for each of the one or more incoherent measurements, performing an inversion for each noise model to form an adaptive filter, and applying an adaptive subtraction with the adaptive filter to form a clean log.

Statement 18: The method of statement 17, further comprising evaluating the log for intrinsic transducer noise in real time.

Statement 19: The method of statements 17 or 18, wherein identifying one or more incoherent measurements is performed by comparing arrival time of two or more raw reflected waveforms within the log.

Statement 20: The method of statement 19, wherein the arrival time of one raw reflected waveforms from the log without intrinsic noise are different and the arrival time of one raw reflected waveforms from the log with intrinsic noise are the same.

It should be understood that, although individual examples may be discussed herein, the present disclosure covers all combinations of the disclosed examples, including, without limitation, the different component combinations, method step combinations, and properties of the system.

It should be understood that the compositions and methods are described in terms of “comprising,” “containing,” or “including” various components or steps, the compositions and methods can also “consist essentially of” or “consist of” the various components and steps. Moreover, the indefinite articles “a” or “an,” as used in the claims, are defined herein to mean one or more than one of the element that it introduces.

For the sake of brevity, only certain ranges are explicitly disclosed herein. However, ranges from any lower limit may be combined with any upper limit to recite a range not explicitly recited, as well as, ranges from any lower limit may be combined with any other lower limit to recite a range not explicitly recited, in the same way, ranges from any upper limit may be combined with any other upper limit to recite a range not explicitly recited. Additionally, whenever a numerical range with a lower limit and an upper limit is disclosed, any number and any included range falling within the range are specifically disclosed. In particular, every range of values (of the form, “from about a to about b,” or, equivalently, “from approximately a to b,” or, equivalently, “from approximately a-b”) disclosed herein is to be understood to set forth every number and range encompassed within the broader range of values even if not explicitly recited. Thus, every point or individual value may serve as its own lower or upper limit combined with any other point or individual value or any other lower or upper limit, to recite a range not explicitly recited.

Therefore, the present examples are well adapted to attain the ends and advantages mentioned as well as those that are inherent therein. The particular examples disclosed above are illustrative only, and may be modified and practiced in different but equivalent manners apparent to those skilled in the art having the benefit of the teachings herein. Although individual examples are discussed, the disclosure covers all combinations of all of the examples. Furthermore, no limitations are intended to the details of construction or design herein shown, other than as described in the claims below. Also, the terms in the claims have their plain, ordinary meaning unless otherwise explicitly and clearly defined by the patentee. It is therefore evident that the particular illustrative examples disclosed above may be altered or modified and all such variations are considered within the scope and spirit of those examples. If there is any conflict in the usages of a word or term in this specification and one or more patent(s) or other documents that may be incorporated herein by reference, the definitions that are consistent with this specification should be adopted.

What is claimed is:

1. A method comprising:
disposing a measurement assembly into a wellbore;
performing a measurement operation in the wellbore with the measurement assembly to record two or more raw reflected waveforms at one or more depths in the wellbore with one or more transducers;
forming a log with the two or more raw reflected waveforms;
dividing the log into two or more subsections;
forming one or more operating subsections from the two or more subsections;
identifying one or more incoherent measurements within the one or more operating subsections;
deriving a noise model for each of the one or more incoherent measurements;
performing an inversion for each noise model to form an adaptive filter; and
applying an adaptive subtraction with the adaptive filter on the one or more operating subsections to remove an intrinsic transducer noise.

2. The method of claim 1, wherein dividing the log into two or more subsections is based at least in part on one or more well attributes.

3. The method of claim 2, wherein the one or more well attributes are depth, amplitude, operating frequency, downhole pressure, or temperature.

4. The method of claim 1, further comprising evaluating the log for intrinsic transducer noise in real time.

5. The method of claim 1, wherein identifying one or more incoherent measurements within the one or more operating subsections is performed by comparing an arrival time to each of the two or more raw reflected waveforms within the operating subsection.

6. The method of claim 5, wherein if the arrival time of two or more raw reflected waveforms are different indicates the intrinsic transducer noise is not present.

7. The method of claim 5, wherein if the arrival time of two or more raw reflected waveforms are identical indicates the intrinsic transducer noise is present.

8. The method of claim 1, wherein the noise model for each of the one or more incoherent measurements is derived using at least a part of the one or more incoherent measurements.

9. The method of claim 1, wherein the inversion is:
\hat{f}=argmin_{f}∥w−f*m∥ₚ,
wherein, f is the adaptive filter, \hat{f} is an inverted adaptive filter formed from the adaptive filter, ∥⋅∥ₚ is an [symbol] p-norm with p≥1, m is the noise model, w is the raw reflected waveforms within the operating subsection and argmin_{f} is argument, answer, or target which minimizes the inverted filter.

10. The method of claim 9, wherein the adaptive subtraction is:
\tilde{w}=w−\hat{f}*m,
wherein \tilde{w} is a clean subsection.

11. The method of claim 9, wherein the adaptive subtraction is:
\tilde{w}=w−f*m,
wherein \tilde{w} is a clean subsection.

12. A system comprising:
one or more transducers configured to record two or more raw reflected waveforms at one or more depths in a wellbore;
an information handling system configured to:
form a log with the two or more raw reflected waveforms;
divide the log into two or more subsections;
form one or more operating subsections from the two or more subsections;
identify one or more incoherent measurements within the one or more operating subsections;
derive a noise model for each of the one or more incoherent measurements;
perform an inversion for each noise model to form an adaptive filter; and
apply an adaptive subtraction with the adaptive filter on the one or more operating subsections to remove intrinsic transducer noise.

13. The system of claim 12, wherein the log is divided based on well attributes, wherein well attributes are depth, amplitude, operating frequency, downhole pressure, or temperature.

14. The system of claim 12, wherein the information handling system is further configured to evaluate the log for intrinsic transducer noise in real time.

15. The system of claim 12, wherein the noise model for each of the one or more incoherent measurements is derived by at least averaging all selected incoherent measurements, wherein the inversion is:
\hat{f}=argmin_{f}∥w−f*m∥ₚ,
wherein f is the adaptive filter, \hat{f} is an inverted adaptive filter formed from the adaptive filter, ∥⋅∥ₚ is an [symbol] p-norm with p≥1, m is the noise model, w is the raw reflected waveforms within the operating subsection and argmin_{f} is argument, answer, or target which minimizes the inverted filter.

16. The system of claim 15, wherein the adaptive subtraction is:
\tilde{w}=w−\hat{f}*m,
wherein \tilde{w} is a clean subsection.

17. A method comprising:
disposing a measurement assembly into a wellbore;
performing a measurement operation in the wellbore with the measurement assembly to record two or more raw reflected waveforms at one or more depths in the wellbore with one or more transducers;
forming a log with the two or more raw reflected waveforms;
identifying one or more incoherent measurements within the log;
deriving a noise model for each of the one or more incoherent measurements;
performing an inversion for each noise model to form an adaptive filter; and
applying an adaptive subtraction with the adaptive filter to form a clean log.

18. The method of claim 17, further comprising evaluating the log for intrinsic transducer noise in real time.

19. The method of claim 17, wherein identifying one or more incoherent measurements is performed by comparing arrival time of two or more raw reflected waveforms within the log.

20. The method of claim 19, wherein the arrival time of one raw reflected waveforms from the log without intrinsic noise are different and the arrival time of one raw reflected waveforms from the log with intrinsic noise are the same.
